(19) United States
(12) Patent Application Publication
(10) Pub. No.: US 2025/0368268 A1
(43) Pub. Date: Dec. 4, 2025

(54) LIGHTWEIGHT PANEL FOR A VEHICLE

(71) Applicants: HYUNDAI MOTOR COMPANY, Seoul (KR); KIA CORPORATION, Seoul (KR); DAESOL AUSYS CO.,LTD, Incheon (KR)

(72) Inventors: Jung-Jong Chun, Hwaseong-si (KR); Joong-Hyun Shin, Hwaseong-si (KR); Min-Jae Lee, Hwaseong-si (KR); Min-Soo Kim, Hwaseong-si (KR); Chae-Wook Lee, Hwaseong-si (KR); Seung-Hu Cho, Siheung-si (KR); Jae-Kwan Ko, Seoul (KR); Min-Ho Kwon, Seoul (KR); Jae-Kyun Namgung, Incheon (KR)

(73) Assignees: HYUNDAI MOTOR COMPANY, Seoul (KR); KIA CORPORATION, Seoul (KR); DAESOL AUSYS CO.,LTD, Incheon (KR)

(21) Appl. No.: 18/962,734

(22) Filed: Nov. 27, 2024

(30) Foreign Application Priority Data
Jun. 3, 2024 (KR) 10-2024-0072391

(51) Int. Cl. B62D 25/06; B32B 3/12; B32B 27/10; B62D 29/04

(52) U.S. Cl. CPC B62D 25/06; B32B 3/12; B32B 27/10; B62D 29/043; B32B 2250/03; B32B 2250/40; B32B 2605/00

(57) ABSTRACT

A lightweight panel for a vehicle includes a honeycomb part including a paper honeycomb having an inside formed in a honeycomb structure and machined to have a predetermined thickness. The panel also includes a reinforcing layer formed of a reinforcing mat and a reinforcing resin, formed on each of upper and lower surfaces of the honeycomb part. The honeycomb part is formed to be thinner toward a perimeter thereof.

### CROSS-REFERENCE TO RELATED APPLICATION

This application claims priority to Korean Patent Application No. 10-2024-0072391, filed on Jun. 3, 2024, which is incorporated herein by reference in its entirety.

### BACKGROUND

### Field

The present disclosure relates to a lightweight panel for a vehicle, which may allow a user to easily handle the panel mounted on a vehicle by applying a lightweight honeycomb structure to the panel.

### Description of Related Art

Various types of panels 120 are included in vehicles to partition an internal space of the vehicle or form an exterior of the vehicle.

For example, FIG. 1 shows a luggage board as an example of a panel 120. The luggage board may be used to separate a cabin and loading space of the vehicle.

A cross section of the panel 120 has a structure as shown in FIG. 2. A honeycomb part 121 is formed by processing a paper honeycomb P. A reinforcing layer 123 is formed on upper and lower surfaces of the honeycomb part 121 by spraying polyurethane after a fiberglass (e.g., glass fiber) mat is fixed to each of the upper and lower surfaces of the honeycomb part 121. The reinforcing layer 123 is formed by saturating the fiberglass mat with the polyurethane. A portion of the polyurethane is saturated (e.g., partially saturated, impregnated) into the honeycomb part 121 to form a saturation layer 122 (e.g., partially saturated layer, impregnation layer 122).

The paper honeycomb, which becomes the honeycomb part 121, may include hexagonal pillars which are continuously formed without any gap, as shown in the enlarged view of FIG. 2. The continuously formed hexagonal pillars may exhibit rigidity. The paper honeycomb may be lightweight due to its composition of a paper material. In particular, the fiberglass mat (e.g., glass fiber mat) forms the reinforcing layer 123 through the polyurethane on the upper and lower surfaces of the honeycomb part 121, thereby further increasing rigidity.

In a state in which the reinforcing layer 123 and the impregnation layer 122 are formed in the honeycomb part 121, a desired shape is manufactured using a thermoforming mold.

Thereafter, when the panel 120, for example, a luggage board, is mounted on the vehicle, and a skin layer 124 is formed by surrounding a lower surface which is not visible (e.g., from an interior of the vehicle) with non-woven fabric 125 and surrounding a visible upper surface with carpet.

However, the panel 120 in the related art has a problem that an area or portion of a vehicle to which the panel may be applied is unavoidably limited to a luggage board, etc. as the overall thickness of honeycomb part 121 is constantly formed.

### SUMMARY

The present disclosure is provided to solve the above mentioned problems and is directed to a lightweight panel, which may be applied or mounted to an outside of a vehicle. A perimeter of a honeycomb part formed of a paper honeycomb may be formed to be thinner than a central portion thereof.

To achieve the above noted objects, according to an embodiment of the present disclosure, a lightweight panel includes a honeycomb part formed by machining a paper honeycomb having an interior formed in a honeycomb structure to have a predetermined thickness, and a reinforcing layer formed of a reinforcing mat and a reinforcing resin, formed on each of upper and lower surfaces of the honeycomb part. The honeycomb part is formed to be thinner toward a perimeter thereof.

The honeycomb part is formed to be stepped toward a perimeter thereof.

Instead of having a honeycomb structure, paper may fill the honeycomb part within a predetermined distance from an end portion of the panel.

A portion of the honeycomb part filled with the paper is seated on a weather strip installed on a body of the vehicle.

A skin layer forming an upper surface of the panel is formed on an upper surface of the reinforcing layer which is formed on an upper portion of the honeycomb part.

The skin layer includes a color layer providing a color of the skin layer, and a clear layer that is provided outside the color layer and is transparent.

The skin layer covers side surfaces of the panel.

A mounting part is provided on a bottom surface of the panel.

The lightweight panel further includes a saturation layer in which a resin sprayed onto the reinforcing layer is saturated into the saturation layer between the honeycomb part and the reinforcing layer.

The panel is applied as a roof panel of the vehicle.

The roof panel includes a plurality of subpanels.

Portions of the plurality of subpanels where the plurality of subpanels are connected are connected to overlap each other.

According to the lightweight panel for a vehicle according to the present disclosure having the above configuration, since the thickness of the perimeter of the panel is formed to be reduced in a portion corresponding to the portion on which the panel is mounted, the panel can be applied to the outside of the vehicle, thereby enabling the vehicle to be lightweight.

The reinforcing layer formed of the fiberglass mat and polyurethane on each of the upper and lower surfaces of the panel can be formed even in the portion of the panel where the thickness of the perimeter of the panel is smallest to apply the lightweight panel to the exterior panel, thereby reducing the weight of the vehicle.

As described above, it is possible to make the exterior panel of the vehicle lightweight, thereby not only increasing the energy efficiency of the vehicle, but also allowing the user to easily detachably attach the exterior panel of the vehicle according to the user's needs.

### BRIEF DESCRIPTION OF THE DRAWINGS

FIG. 1 is a perspective view of a luggage board according to an example of a panel in the related art.

FIG. 2 is a cross-sectional view along line I-I in FIG. 1.

FIG. 3 is a perspective view of a vehicle to which a lightweight panel for a vehicle according to the present disclosure is applied.

FIG. 4 is a perspective view showing a roof panel detached from a vehicle.

FIG. 5 is a cross-sectional view along line II-II in FIG. 3.

FIG. 6 is a cross-sectional view along line III-III in FIG. 3.

FIG. 7 is a cross-sectional view along line IV-IV in FIG. 3.

FIG. 8 is an enlarged view of portion A in FIG. 5.

FIG. 9 is a bottom view of an example where the lightweight panel for a vehicle according to the present disclosure is applied as the roof panel.

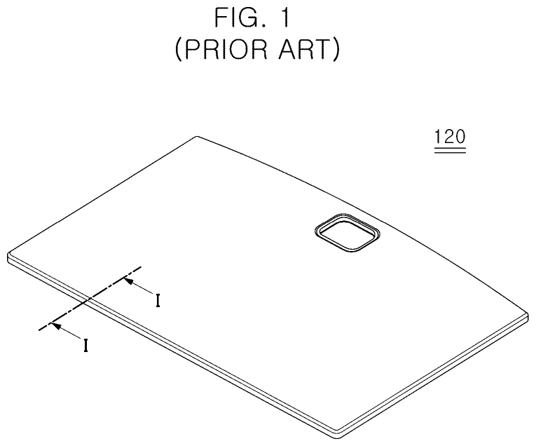

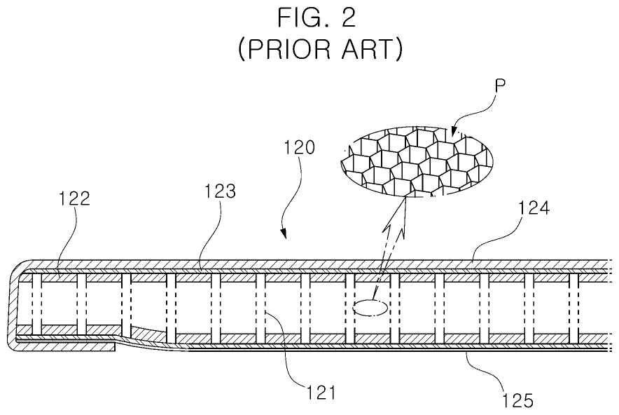

### DETAILED DESCRIPTION

Hereinafter, a lightweight panel for a vehicle, according to some embodiments of the present disclosure, is described in detail with reference to the accompanying drawings. When a component, device, element, or the like of the present disclosure is described as having a purpose or performing an operation, function, or the like, the component, device, or element or the like should be considered herein as being “configured to” meet that purpose or perform that operation or function.

According to an embodiment of the present disclosure, the lightweight panel for a vehicle includes: a honeycomb part 21 including a paper honeycomb having an interior formed in a honeycomb structure. The honeycomb structure is machined to have a predetermined thickness. The lightweight panel further includes reinforcing layer 23 formed of a reinforcing mat and a reinforcing resin and formed on each of upper and lower surfaces of the honeycomb part 21. The honeycomb part 21 is formed to be thinner toward a perimeter thereof.

The honeycomb part 21 is formed by milling a paper honeycomb.

The paper honeycomb includes hexagonal pillars which are continuously formed without any gap using paper. When the paper honeycomb is manufactured, its thickness is constantly formed over an entire area of the paper honeycomb.

However, when a panel 20 manufactured using the honeycomb part 21 is included in or mounted to a vehicle 1, each portion of the honeycomb part 21 should have a different thickness. Thus, the honeycomb part 21 may be formed in advance through milling machining such that each portion has a different thickness.

When the paper honeycomb is milled into the honeycomb part 21, the paper honeycomb should be face-milled. Thus, the paper honeycomb is machined into the honeycomb part 21 using a face cutter.

A hexagonal pillar structure formed in the honeycomb part 21 supports a load acting in a vertical direction.

A reinforcing layer 23 and a saturated layer 22 (e.g., partially saturated layer 22, impregnation layer 22) are formed on each of the upper and lower surfaces of the honeycomb part 21. To manufacture the panel 20, thermal molding should be performed. Before the thermal molding, the reinforcing layer 23 and the saturated layer 22 are formed on each of the upper and lower surfaces of the honeycomb part 21.

To form the reinforcing layer 23, a mat made of fiberglass (e.g., glass fiber) is disposed on the upper and lower surfaces of the honeycomb part 21. A resin made of polyurethane is sprayed to form the reinforcing layer 23 on each of the upper and lower surfaces of the honeycomb part 21. The reinforcing layer 23 increases the rigidity of the upper and lower surfaces of the honeycomb part 21 by a mixture of the fiberglass mat and the polyurethane.

A portion of the polyurethane sprayed to form the reinforcing layer 23 is saturated or absorbed into the honeycomb part 21 to form the saturation layer 22.

The reinforcing layer 23 together with the honeycomb part 21 becomes a rigid part that exhibits rigidity in the panel 20.

Meanwhile, the honeycomb part 21 is formed to be thinner toward the perimeter of the panel 20.

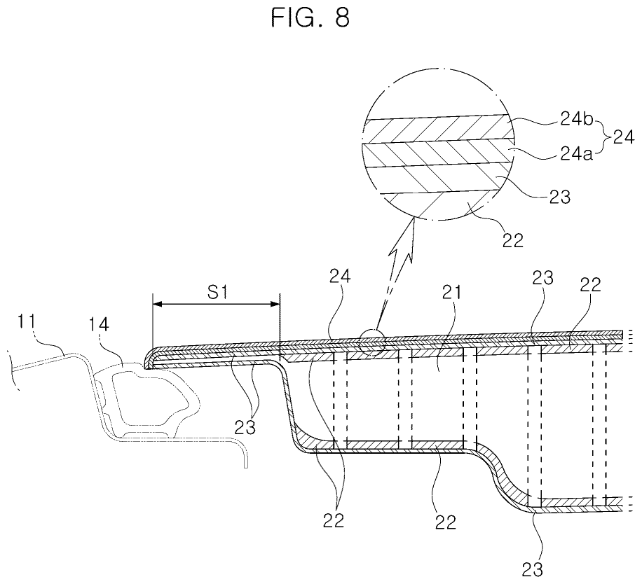

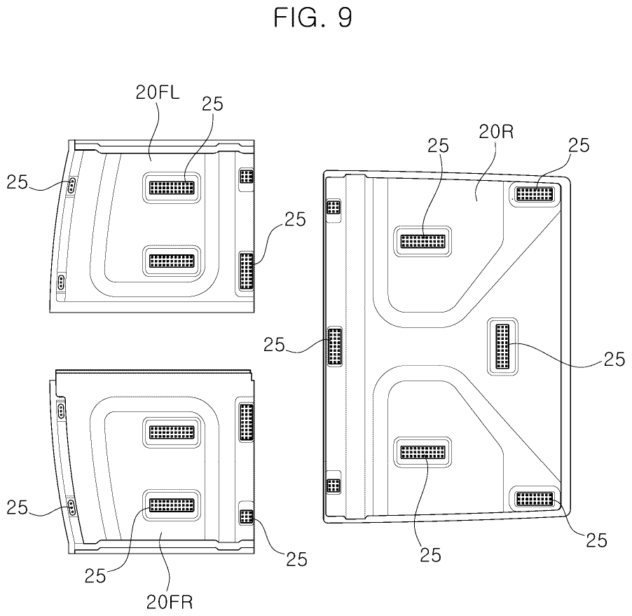

In particular, the panel 20 according to the present disclosure, for example, roof panel 20, is mounted outside of the vehicle 1. When the panel 20 is mounted on the vehicle 1, an end portion of the panel 20 should be seated on a vehicle body. A gap between the panel 20 and the vehicle body should be sealed. Therefore, the honeycomb part 21 may be thinner on a portion adjacent to or along the perimeter of the honeycomb part 21 and is formed to be stepped. In other words, as shown in FIG. 8, a stepped portion of the honeycomb part 21 is formed to be thinner than a portion of the honeycomb part 21 that is not stepped.

Here, a portion of the panel 20 within a predetermined distance from the end portion of the panel 20, for example, in section S1 in FIG. 8, is formed to have a thinnest or smallest thickness compared to other portions of the panel 20. In other words, in the section S1, thermal molding is performed when the reinforcing layer 23 and the saturation layer 22 are provided on the honeycomb part 21. As the above components are completely pressed by a mold during thermal molding, the honeycomb structure is collapsed and internal pores are eliminated. Thus, in the section S1, paper and the polyurethane fully fill the honeycomb part 21 without any empty space.

A skin layer 24 is formed on an upper surface of the reinforcing layer 23 formed at the outermost side of the panel 20, in other words, on an upper portion of the honeycomb part 21.

The skin layer 24 includes a color layer 24a that provides a color of the skin layer 24, and a transparent clear layer 24b provided outside the color layer 24a.

A color of the color layer 24a becomes the color of the skin layer 24. In other words, the color applied in a manufacturing process of the color layer 24a becomes the color of the skin layer 24, which becomes the color of the panel 20. The color layer 24a is made of a material with good heat resistance and impact resistance. A desired color may be easily applied to the panel 20 in the manufacturing process. Acrylonitrile-butadiene-styrene (ABS) may be an example of a material for the color layer 24a.

The clear layer 24b is provided outside the color layer 24a to protect the color layer 24a. An example of a material of the clear layer 24b may be Polymethyl methacrylate (PMMA). The PMMA is a material that is stronger than glass and transparent and serves to protect the color layer 24a at the outside of the color layer 24a.

The skin layer 24 covers side surfaces of the panel 20 to protect the side surfaces of the panel 20. Referring to FIG. 8, the skin layer 24 covers the side surfaces of the panel 20 to bring an end portion of the skin layer 24 into contact with an end portion of the reinforcing layer 23 located on a lower portion of the honeycomb part 21. Accordingly, side ends of the honeycomb part 21 and the reinforcing layer 23 may be protected.

An example in which the lightweight panel for a vehicle according to the present disclosure having the above configuration is applied to the vehicle 1 is described as follows.

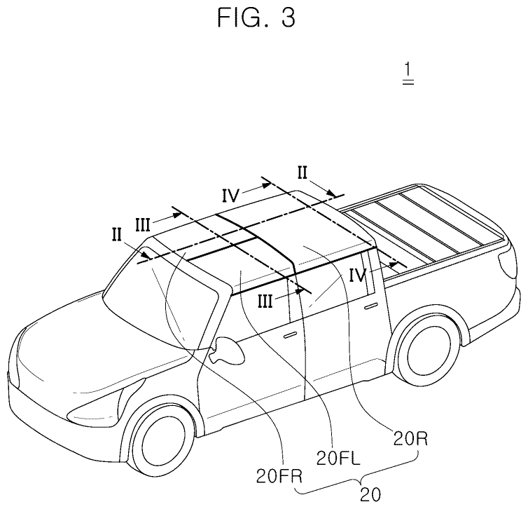

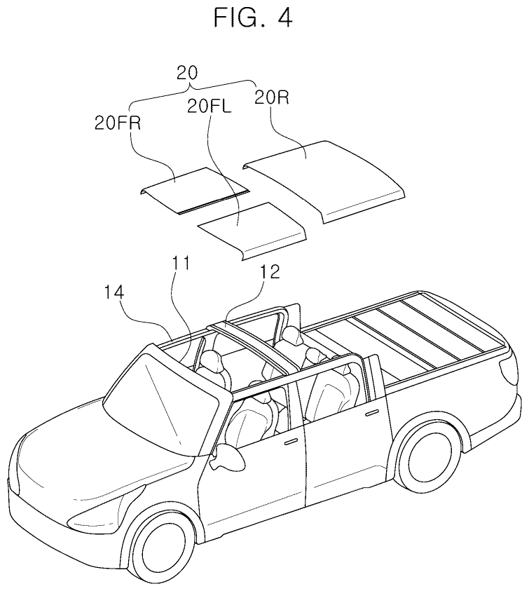

FIGS. 3 and 4 show an example in which the panel 20 according to the present disclosure is applied as the roof panel 20 of the vehicle 1. In the vehicle shown in FIGS. 3 and 4, the roof panel 20 is installed to be detachably attached or coupled to the vehicle 1 to further expand the sense of openness, for example, perceived by a passenger of the vehicle in a limited traveling environment. Meanwhile, the panel 20 may be applied not only as the roof panel 20, but also as an exterior panel such as a hood, a tailgate, or a trunk lid of the vehicle.

A front rail 11 and a center rail 12 are formed on a roof of the vehicle 1 and may extend in a width direction of the vehicle 1. A roof side rail 13 is formed on or along side surfaces of the roof and may extend in a longitudinal direction of the vehicle 1. The roof panel 20 is mounted through the front rail 11, the center rail 12, and the roof side rail 13.

The roof panel 20 is partitioned into a plurality of subpanels 20FL, 20FR, and 20R. A cross-sectional structure of each of the subpanels 20FL, 20FR, and 20R has the same configuration as described above.

The subpanels 20FL, 20FR, and 20R include the first subpanel 20FL that becomes a front left roof panel, a second subpanel 20FR that becomes a front right roof panel, and a third subpanel that becomes a rear roof panel 20R.

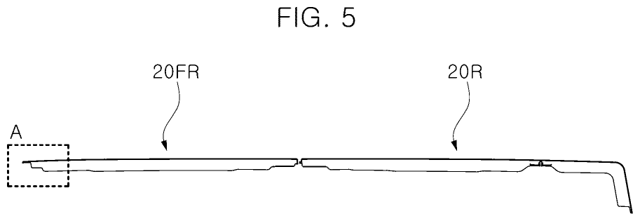

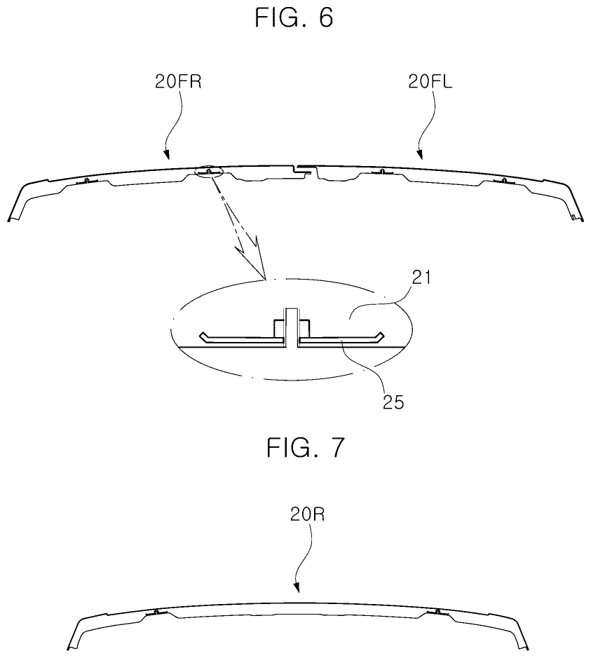

FIGS. 5 and 7 show a cross-section of each of the first subpanel 20FL, the second subpanel 20FR, and the third subpanel 20R. Portions of the first subpanel 20FL, the second subpanel 20FR, and the third subpanel 20R which are connected (e.g., to another of the first subpanel 20FL, the second subpanel 20FR, or the third subpanel 20R) are connected to overlap each other, and a sealing is provided in the gaps therebetween. For example, the portion where the first subpanel 20FL and the second subpanel 20FR may be connected is connected such that the subpanels overlap.

Meanwhile, portions where the perimeters of the first subpanel 20FL, the second subpanel 20FR, and the third subpanel 20R are connected to a body of the vehicle 1 are connected as shown in FIG. 8. An end portion of each of the subpanels 20FL, 20FR, and 20R, particularly, front ends of the first subpanel 20FL and the second subpanel 20FR, are seated on a weather strip 14 mounted on the front rail 11.

A mounting part 25 for mounting another device is provided on a bottom surface of each of the subpanels 20FL, 20FR, and 20R. To mount another device on the bottom surfaces of the subpanels 20FL, 20FR, and 20R, another device is mounted by fastening a fastening such as a bolt to the mounting part 25.

The present disclosure has been described with reference to the example embodiments and the drawings, but the present disclosure is not limited thereby. The present disclosure may be carried out in various forms by those having ordinary skill in the art, to which the present disclosure pertains, within the technical spirit of the present disclosure and the scope of equivalents to the appended claims.

What is claimed is:

1. A lightweight panel for a vehicle, comprising:
a honeycomb part formed by machining a paper honeycomb having an interior formed in a honeycomb structure to have a predetermined thickness; and
a reinforcing layer formed of a reinforcing mat and a reinforcing resin, formed on each of upper and lower surfaces of the honeycomb part,
wherein the honeycomb part is formed to be thinner toward a perimeter thereof.

2. The lightweight panel of claim 1, wherein the honeycomb part is formed to be stepped toward the perimeter thereof.

3. The lightweight panel of claim 2, wherein within a predetermined distance from an end portion of the panel, the honeycomb part is filled with paper instead of having the honeycomb structure.

4. The lightweight panel of claim 3, wherein a portion of the honeycomb part filled with the paper is seated on a weather strip installed on a body of the vehicle.

5. The lightweight panel of claim 1, wherein a skin layer forming an upper surface of the panel is formed on an upper surface of the reinforcing layer which is formed on an upper portion of the honeycomb part.

6. The lightweight panel of claim 5, wherein the skin layer includes:
a color layer providing a color of the skin layer; and
a clear layer that is provided outside the color layer and is transparent.

7. The lightweight panel of claim 5, wherein the skin layer covers side surfaces of the panel.

8. The lightweight panel of claim 7, wherein a mounting part is provided on a bottom surface of the panel.

9. The lightweight panel of claim 1, further comprising a saturation layer in which a resin sprayed onto the reinforcing layer is saturated into the saturation layer between the honeycomb part and the reinforcing layer.

10. The lightweight panel of claim 1, wherein the panel is used as a roof panel of the vehicle.

11. The lightweight panel of claim 10, wherein the roof panel includes a plurality of subpanels.

12. The lightweight panel of claim 11, wherein portions of the plurality of subpanels where the plurality of subpanels are connected are connected to overlap each other.
